(19) United States
(12) Patent Application Publication
(10) Pub. No.: US 2017/0012370 A1
(43) Pub. Date: Jan. 12, 2017

(54) CONNECTOR-EQUIPPED ELECTRICAL WIRE AND METHOD FOR MANUFACTURING SAME

(71) Applicants: AutoNetworks Technologies, Ltd., Yokkaichi, Mie (JP); Sumitomo Wiring Systems, Ltd., Yokkaichi, Mie (JP); Sumitomo Electric Industries, Ltd., Osaka-shi. Osaka (JP)

(72) Inventors: Takaaki HAMAGUCHI, Yokkaichi, Mie (JP); Tatsuya HASE, Yokkaichi, Mie (JP); Katsufumi MATSUI, Yokkaichi, Mie (JP); Kazuo NAKASHIMA, Yokkaichi, Mie (JP)

(21) Appl. No.: 15/110,667

(22) PCT Filed: Dec. 23, 2014
(86) PCT No.: PCT/JP2014/084008

§ 371 Date: Sep. 30, 2016

(30) Foreign Application Priority Data
Jan. 9, 2014 (JP) 2014-002249

(51) Int. Cl. H01R 4/70; H01R 43/24; C09J 177/00; C09J 167/00; H01B 3/44; C09J 123/26

(52) U.S. Cl. CPC H01R 4/70; H01B 3/441; C09J 123/26; C09J 177/00; C09J 167/00; H01R 43/24

(57) ABSTRACT

A connector-equipped electrical wire has a coated electrical wire, a terminal metal fitting, a connector housing, and an adhesive. The coated electrical wire has a conductor and a coating material that is made of a cross-linked polyethylene resin and with which the conductor is coated. The terminal metal fitting is connected to an end portion of the coated electrical wire. The connector housing in which the end portion is embedded is integrally formed with the coated electrical wire and the terminal metal fitting. The adhesive is disposed in a portion of a gap located between the coating material of the end portion and the connector housing, and seals the gap.

### TECHNIAL FIELD

The present invention relates to a connector-equipped electrical wire (that is, an electrical wire equipped with a connector) and a method for manufacturing the same.

### BACKGROUND ART

Wire harnesses such as an AC harness that connects an inverter and a motor, for example, are used in hybrid cars, electric cars, and the like. A connector-equipped electrical wire used in the wire harness has a coated electrical wire in which the periphery of a conductor is coated with a coating material, and a connector that is connected to an end portion of the coated electrical wire. An inexpensive and highly insulative cross-linked polyethylene resin is often used as the coating material.

Also, in order to prevent water or the like from entering the connector, the connector-equipped electrical wire is often provided with a sealing means for liquid-tightly sealing a gap between the coated electrical wire and the connector. For example, Patent Document 1 discloses a rubber stopper to be used as the sealing means The rubber stopper is used by being inserted into a cavity of a connector housing in a state in which the coated electrical wire passes through the rubber stopper.

Meanwhile, in recent years, in order to reduce the number of parts and the size of a connector, sometimes, a connector and a coated electrical wire are integrally formed by insert molding. Studies have been conducted on liquid-tightly sealing a gap formed between the coated electrical wire and the sealing means by insert molding in a state in which the sealing means is disposed in the coated electrical wire in advance.

An adhesive conforming to the coating material, and a sealing material that has been conventionally used in an electrical component disposed in the engine room of a car have been studied as the sealing means There are moisture-curing, UV-curing, thermosetting, and hot-melt sealing materials, for example, and resins such as a urethane-based, polyester-based, acrylate-based, or silicone-based resin are used. For example, Patent Document 2 discloses an example of a silicone-based resin that is cured by irradiation of ultraviolet rays.

### CITATION LIST

### Patent Documents

Patent Document 1: JP 2013-152803A

Patent Document 2: JP 2007-130836A

### SUMMARY OF INVENTION

### Technical Problem

However, if a connector and a coated electrical wire having a coating material made of a cross-linked polyethylene resin are integrally formed by insert molding, the cross-linked polyethylene resin is problematic in that an adhesive or the like does not strongly adhere to the cross-linked polyethylene resin. That is, an adhesive, a thermosetting sealing material, and a hot-melt sealing material that are used generally do not have a sufficient force of adhering to the cross-linked polyethylene resin. Therefore, the adhesive or the like easily separates from the cross-linked polyethylene resin.

Also, there is a risk that the moisture required for curing will not be sufficiently supplied to the inner portion of a moisture-curing sealing material, and the sealing material will not be completely cured. Similarly, it is difficult for the entire UV-curing sealing material to be irradiated with ultraviolet rays, and thus there is a risk that the sealing material will not be completely cured. The incompletely cured sealing material does not have a sufficient force of adhering to the cross-linked polyethylene resin, and thus it easily separates from the cross-linked polyethylene resin.

As described above, if a conventional adhesive or the like is used, since the force of adhering to the cross-linked polyethylene resin is not sufficient, the adhesive or the like easily separates from the cross-linked polyethylene resin. Therefore, a gap is easily formed between the coated electrical wire and the connector, and it is difficult to liquid-tightly seal the gap between them.

The present invention has been achieved in light of the above-described issues and is to provide a connector-equipped electrical wire that has excellent waterproofness and a method for manufacturing the same.

### Solution to Problem

An aspect of the present invention is a connector-equipped electrical wire including:

a coated electrical wire having a conductor and a coating material that is made of a cross-linked polyethylene resin and with which the conductor is coated;

a terminal metal fitting connected to an end portion of the coated electrical wire;

a connector housing in which the end portion is embedded and that is integrally formed with the coated electrical wire and the terminal metal fitting; and

an adhesive that is disposed in a portion of a gap located between the coating material at the end portion and the connector housing, and seals the gap,

in which the adhesive contains one or more resins selected from the group consisting of a modified polyolefin-based resin, a modified polyamide resin, and a modified polyester resin, as an adhesive component, and

a mixed layer in which the adhesive and the coating material are mixed is formed between the adhesive and the coating material.

Also, another aspect of the present invention is a method for manufacturing a connector-equipped electrical wire, the method including a terminal connection step of connecting a terminal metal fitting to an end portion of a coated electrical wire having a conductor and a coating material that is made of a cross-linked polyethylene resin and with which a periphery of the conductor is coated;

an adhesive application step of applying an adhesive containing one or more resins selected from the group consisting of a modified polyolefin-based resin, a modified polyamide resin, and a modified polyester resin and a non-protonic organic solvent to a surface of the coating material at the end portion; and

a connector molding step of forming a connector housing integrally with the coated electrical wire and the terminal metal fitting by insert molding in a state in which the non-protonic organic solvent remains in the adhesive, such that the end portion is embedded.

### Advantageous Effects of Invention

The connector-equipped electrical wire has an adhesive that is disposed in a portion of a gap located between the coating material at the end portion and the connector housing, and seals the gap. A mixed layer in which the adhesive and the coating material are mixed is formed between the adhesive and the coating material. In this manner, the adhesive and the coating material strongly adhere to each other due to the adhesive and the coating material being mixed. Therefore, the adhesive is unlikely to separate from the coating material and the gap is liquid-tightly sealed by the adhesive. As a result, the connector-equipped electrical wire has excellent waterproofness.

Also, the method for manufacturing a connector-equipped electrical wire includes the adhesive application step of applying the adhesive containing one or more resins selected from the group consisting of a modified polyolefin-based resin, a modified polyamide resin, and a modified polyester resin and a non-protonic organic solvent to the surface of the coating material. The connector housing is formed by insert molding in a state in which the non-protonic organic solvent remains in the adhesive diluent in the connector molding step.

Heat and pressure are applied by insert molding to the end portion that is embedded in the connector housing, in a state in which the non-protonic organic solvent is present. This forms the mixed layer and the adhesive and the coating material strongly adhere to each other. As a result, a connector-equipped electrical wire having excellent waterproofness can be easily obtained.

### BRIEF DESCRIPTION OF DRAWINGS

FIG. 1 is a diagram illustrating a connector-equipped electrical wire according to Working Example 1.

FIG. 2 is a transmission electron microscope photograph of the vicinity of an interface between a coating material and an adhesive in Working Example 1.

FIG. 3 is an illustrative diagram of a connector-equipped electrical wire according to Working Example 1, with (A) showing a state after a terminal connection step is carried out and (B) showing a state after an adhesive application step is carried out.

FIG. 4 is a transmission electron microscope photograph of the vicinity of an interface between a coating material and an adhesive in Working Example 2 when an adhesive that is not diluted by a non-protonic organic solvent is used.

FIG. 5 is a transmission electron microscope photograph of the vicinity of an interface between a coating material and an adhesive in a comparative example when an adhesive diluent is applied to a coating material and dried.

### DESCRIPTION OF EMBODIMENTS

From the viewpoint of heat resistance and insulation properties, a connector housing of the connector-equipped electrical wire is usually formed by an aromatic nylon resin, a polybutylene terephthalate resin, or the like.

An adhesive component included in the adhesive is one or more resins selected from the group consisting of a modified polyolefin-based resin, a modified polyamide resin, and a modified polyester resin. Since these resins have good adhesiveness to the connector housing, the connector housing and the adhesive are unlikely to separate from each other.

Also, the adhesive contains a non-protonic organic solvent in the method for manufacturing a connector-equipped electrical wire. The non-protonic organic solvent may be included in the adhesive in advance or may be separately mixed in the adhesive.

If the adhesive contains the non-protonic organic solvent in an excessively small amount, the amount of the non-protonic organic solvent remaining in the adhesive excessively decreases in the connector molding step. Therefore, there is a risk that a mixed layer will be unlikely to be formed between the adhesive and the coating material after the connector molding step is completed. Also, the viscosity of the adhesive easily increases in this case. Therefore, air bubbles are easily mixed when the adhesive is applied, and there is a risk that the air bubbles will remain after the connector molding step is completed. Because such air bubbles reduce the quality, these air bubbles are not preferable. On the other hand, if the adhesive contains an excessively large amount of the non-protonic organic solvent, there is a risk that the viscosity of the adhesive will excessively decrease and it will be difficult to apply a sufficient amount of the adhesive to the surface of the coating material.

As described above, the content of the non-protonic organic solvent in the adhesive is adjusted in accordance with the type of adhesive and non-protonic organic solvent to be used such that the adhesive has viscosity suitable to be applied to the surface of the coating material and a sufficient amount of the non-protonic organic solvent remains in the adhesive in the connector molding step.

It is preferable that the above-described non-protonic organic solvent is a solvent selected from the group consisting of aromatic hydrocarbon and methyl ethyl ketone, or a solvent in which two or more thereof are mixed. These compounds can dilute the adhesive without dissolving the connector housing and the coating material. Also, these compounds easily form the above-described mixed layer at the time of insert molding. Therefore, in this case, the coating material and the adhesive strongly adhere to each other and are unlikely to separate from each other. As a result, the connector-equipped electrical wire has excellent waterproofness.

### WORKING EXAMPLES

### Working Example 1

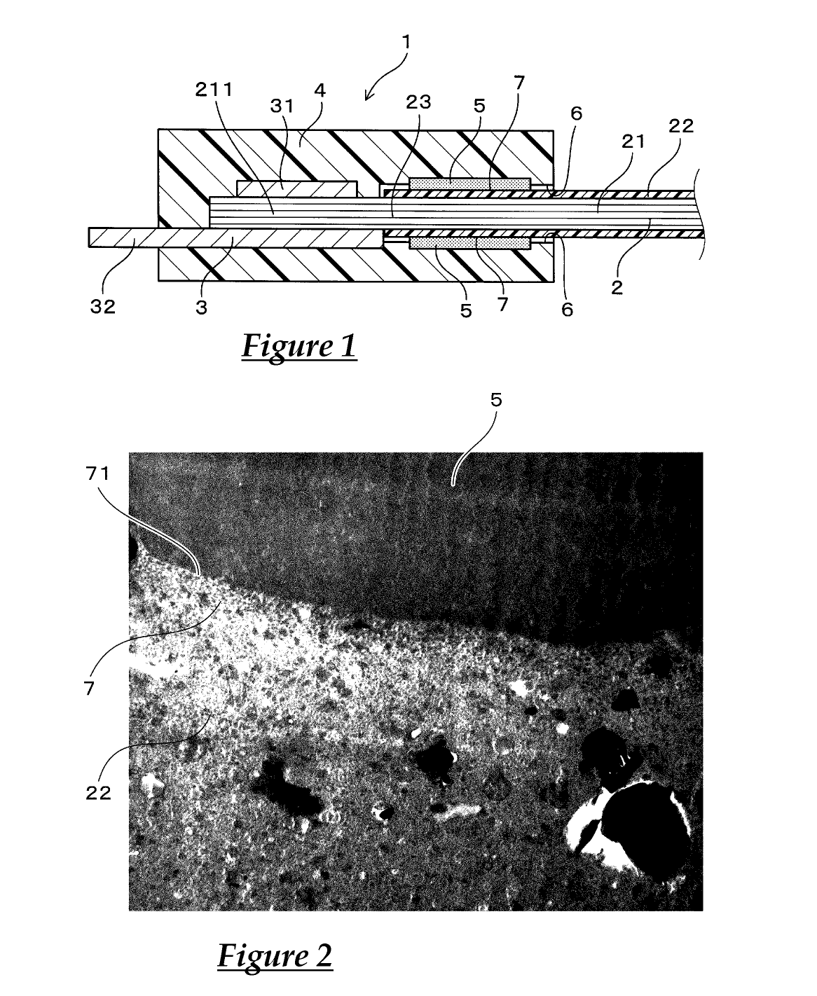

Working examples of the above-described connector-equipped electrical wire will be described with reference to FIGS. 1 to 3. As shown in FIG. 1, a connector-equipped electrical wire 1 has a coated electrical wire 2, a terminal metal fitting 3, a connector housing 4, and an adhesive 5. The coated electrical wire 2 has a conductor 21 and a coating material 22 that is made of a cross-linked polyethylene resin and with which the conductor 21 is coated. The terminal metal fitting 3 is connected to an end portion 23 of the coated electrical wire 2. The connector housing 4 in which the end portion 23 is embedded is integrally formed with the coated electrical wire 2 and the terminal metal fitting 3.

The adhesive 5 is disposed in a portion of a gap 6 located between the coating material 22 at the end portion 23 and the connector housing 4, and seals the gap 6. Also, the adhesive 5 contains one or more resins selected from the group consisting of a modified polyolefin-based resin, a modified polyamide resin, and a modified polyester resin as an adhesive component. As shown in FIG. 2, a mixed layer 7 in which the adhesive 5 and the coating material 22 are mixed is formed between the adhesive 5 and the coating material 22.

As shown in FIG. 1, the coated electrical wire 2 is obtained by the periphery of a copper wire as the conductor 21 being coated with the coating material 22 made of a cross-linked polyethylene resin. The end portion 23 of the coated electrical wire 2 has a terminal connection portion 211 in which the conductor 21 is exposed from the coating material 22. Note that the coated electrical wire 2 used in this example is “EX-30” available from Sumitomo Electric Industries. Ltd.

The terminal metal fitting 3 has a crimped portion 31 crimped to the terminal connection portion 211 and a contact portion 32 that serves as a point of electrical contact with a partner terminal. The crimped portion 31 is crimped to the terminal connection portion 211. Accordingly, the conductor 21 is connected to the terminal metal fitting 3. Also, the contact portion 32 protrudes outward of the connector housing 4.

An adhesive 5 is applied to the surface of the coating material 22 at the end portion 23 over the entire circumference of the coated electrical wire 2. The adhesive 5 contains a modified polyolefin resin as an adhesive component. The mixed layer 7 in which the adhesive 5 and the coating material 22 are mixed is formed between the adhesive 5 and the coating material 22. Note that the adhesive 5 used in this example is “PPET1401SG” available from TOAGOSEI CO., LTD., and contains a solvent in which toluene and n-hexane are mixed.

In order to check a detailed structure of the mixed layer 7, the vicinity of the interface between the adhesive 5 and the coating material 22 was observed with a TEM (transmission electron microscope). The sample used in the TEM observation was a thin piece collected from the connector-equipped electrical wire 1, containing the mixed layer 7. A TEM photograph of a sample subjected to electron staining with RuO₄ is shown in FIG. 2.

As is understood from FIG. 2, the mixed layer 7 whose color changes continuously from the coating material 22 toward the adhesive 5 was observed between the adhesive 5 exhibiting a relatively dark color and the coating material 22 exhibiting a color that is lighter than that of the adhesive 5. Although a border 71 between the mixed layer 7 and the adhesive 5 was clearly confirmed, the border between the mixed layer 7 and the coating material 22 was not clear. Also, the thickness of the mixed layer 7 was 1 to 3 μm and the mixed layer 7 was formed over the entire surfaces between the adhesive 5 and the coating material 22.

The connector housing 4 is integrally formed with the coated electrical wire 2 and the terminal metal fitting 3 such that the end portion 23 of the coated electrical wire 2 is embedded. That is, the adhesive 5, the terminal connection portion 211, and the crimped portion 31 of the terminal metal fitting 3 are embedded in the connector housing 4, and the contact portion 32 of the terminal metal fitting 3 protrudes outward of the connector housing 4. Note that the connector housing 4 of this example is made of a polybutylene terephthalate resin (“551HS” available from POLYPLASTICS CO., LTD.)

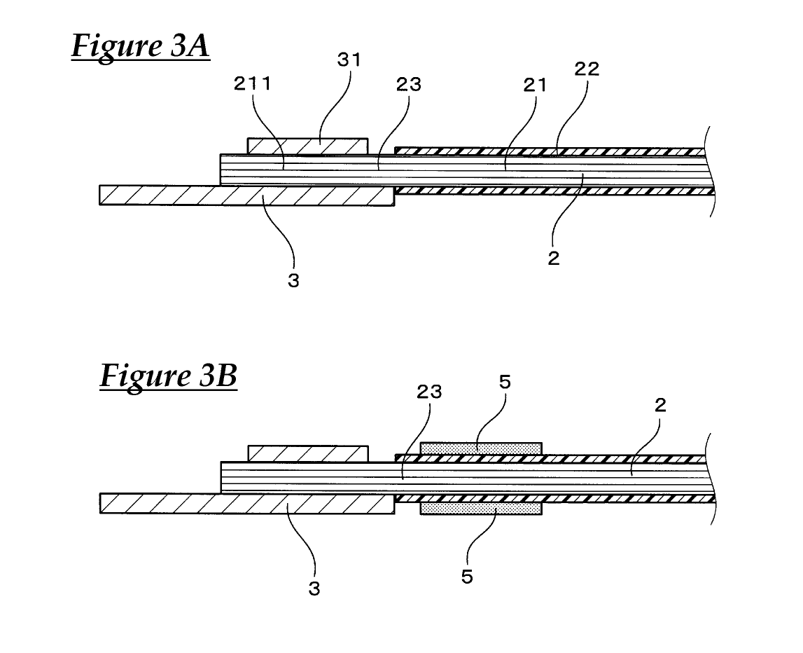

Next, a method for manufacturing the connector-equipped electrical wire 1 will be described. When the connector-equipped electrical wire 1 is manufactured, first, a terminal connection step of connecting the terminal metal fitting 3 to the end portion 23 of the coated electrical wire 2 having the conductor 21 and the coating material 22 that is made of a cross-linked polyethylene resin and with which the periphery of the conductor 21 is coated is carried out (FIG. 3(A)). Next, an adhesive application step of applying the adhesive 5 containing one or more resins selected from the group consisting of a modified polyolefin-based resin, a modified polyamide resin, and a modified polyester resin and a non-protonic organic solvent to the surface of the coating material 22 at the end portion 23 of the coated electrical wire 2 is carried out (FIG. 3(B)). Then, a connector molding step of forming the connector housing 4 integrally with the coated electrical wire 2 and the terminal metal fitting 3 by insert molding in a state in which the non-protonic organic solvent remains in the adhesive 5, such that the end portion 23 is embedded is carried out.

In the terminal connection step, the coating material 22 at the front end of the end portion 23 is removed in advance and the coated electrical wire 2 is provided with the terminal connection portion 211. The terminal connection portion 211 of the coated electrical wire 2 is inserted into the crimped portion 31 of the terminal metal fitting 3, which has an approximately annular shape. Crimping is performed on the crimped portion 31 in a state in which the terminal connection portion 211 is inserted into the crimped portion 31, and thus the terminal metal fitting 3 is crimped to the conductor 21. As a result, the terminal metal fitting 3 is connected to the end portion 23 of the coated electrical wire 2.

In the adhesive application step, an adhesive diluent obtained by diluting the adhesive 5 with toluene was prepared in advance, and the adhesive diluent was applied to the coating material 22. The adhesive diluent was produced by mixing the adhesive 5 and toluene such that the adhesive diluent contains the adhesive 5 in an amount of 50 to 90 mass % of the entire diluent. Note that if the amount of the mixed adhesive 5 was at least 95 mass %, the viscosity of the adhesive diluent increased excessively and air bubbles tended to be mixed in when the adhesive 5 was applied to the coating material 22. On the other hand, if the amount of the mixed adhesive 5 was not more than 30 mass %, the viscosity of the adhesive diluent decreased excessively, and the adhesive 5 could not be applied to the coating material 22.

Also, in this example, after the adhesive application step, the coated electrical wire 2 to which the adhesive diluent was applied was left to stand in a draft chamber and a drying step of air drying the adhesive diluent was carried out. Note that under such conditions, the non-protonic organic solvent included in the adhesive does not volatilize completely and remains in the adhesive after the drying step.

In the housing formation step, insert molding is performed in a state in which the end portion 23 of the coated electrical wire 2 on which the adhesive 5 is disposed and the crimped portion 31 of the terminal metal fitting 3 are arranged in a metal mold. Accordingly, the connector housing 4 is formed and the end portion 23 and the crimped portion 31 are embedded in the connecter housing 4. Also, a mixed layer in which the coating material 22 and the adhesive 5 are mixed is formed between the coating material 22 at the end portion 23 and the adhesive 5 due to heat and pressure applied at the time of insert molding. Note that the temperature of the metal mold at the time of insert molding was 40 to 80° C. and a force of holding pressure after the resin was filled was 10 to 100 MPa.

As described above, the connector-equipped electrical wire 1 shown in FIG. 1 is produced.

Next, the effects of this example will be described. The connector-equipped electrical wire 1 includes the adhesive 5 that is disposed in a portion of the gap 6 located between the coating material 22 at the end portion 23 and the connector housing 4, and that seals the gap 6. The mixed layer 7 in which the adhesive 5 and the coating material 22 are mixed is formed between the adhesive 5 and the coating material 22. Therefore, the adhesive 5 is unlikely to separate from the coating material 22 and the gap 6 is liquid-tightly sealed by the adhesive 5. As a result, the connector-equipped electrical wire 1 has excellent waterproofness.

Also, the method for manufacturing the connector-equipped electrical wire 1 includes the adhesive application step of applying the adhesive 5 containing a modified polyolefin-based resin and a non-protonic organic solvent to the surface of the coating material 22. The connector housing 4 is formed by, in the connector molding step, insert molding in a state in which the non-protonic organic solvent remains in the adhesive 5.

Therefore, the mixed layer 7 is formed by heat and pressure at the time of insert molding, and the adhesive 5 and the coating material 22 strongly adhere to each other. As a result, a connector-equipped electrical wire 1 having excellent waterproofness can be easily obtained. Although the mechanism of the formation of the mixed layer 7 is not exactly clear at present, it is inferred that, from the TEM photograph shown in FIG. 2, the mixed layer 7 is formed by the adhesive 5 and the non-protonic organic solvent permeating through the coating material 22.

Also, the non-protonic organic solvent of this example is toluene classified into aromatic hydrocarbon. Therefore, it is possible to dilute the adhesive 5 without dissolving the connector housing 4 and the coating material 22. Also, toluene easily forms the mixed layer 7 at the time of insert molding. Therefore, the coating material 22 and the adhesive 5 strongly adhere to each other and are unlikely to separate from each other. As a result, the connector-equipped electrical wire 1 has excellent waterproofness.

As described above, the connector-equipped electrical wire 1 has excellent waterproofness.

### Working Example 2

This example is an example of the connector-equipped electrical wire 1 in which an adhesive 5 is used that is not diluted by a non-protonic organic solvent. The connector-equipped electrical wire 1 of this example was produced with a method similar to that in Working Example 1, except that instead of the adhesive diluent, the adhesive 5 was applied to the coating material 22 in the adhesive application step of Working Example 1.

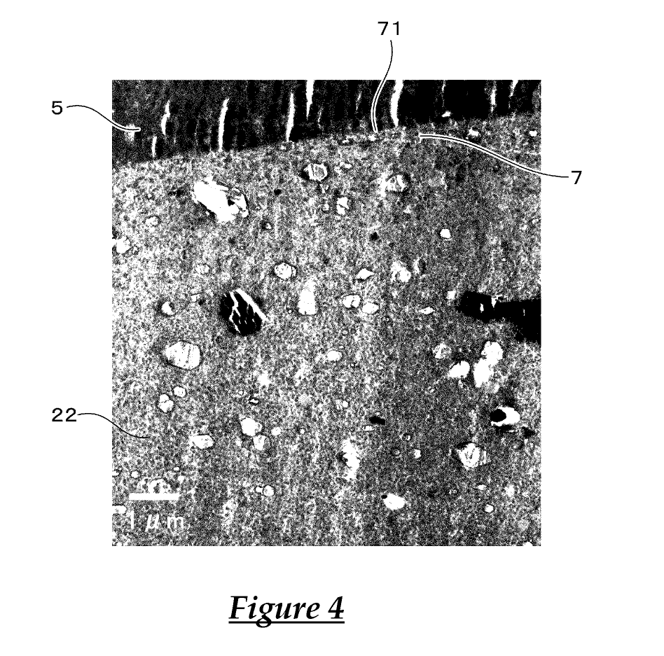

Next, the vicinity of the interface between the adhesive 5 and the coating material 22 in the connector-equipped electrical wire 1 of this example was observed by a TEM. A TEM photograph of a sample subjected to electron staining with RuO₄ is shown in FIG. 4. As is understood from FIG. 4, although less clear than in Working Example 1, a mixed layer 7 whose color changed continuously from the coating material 22 toward the adhesive 5 was observed between the adhesive 5 and the coating material 22.

Thus, if the adhesive 5 contains a non-protonic organic solvent, the mixed layer 7 is formed without separate dilution. It is conceivable that the reason why the mixed layer 7 in the connector-equipped electrical wire 1 of this example was less clear than in Working Example 1 is that the content of the non-protonic organic solvent included in the adhesive 5 when applied to the coating material 22 is lower than that in Working Example 1.

### Comparative Example

This example is an example in which insert molding is not performed after the adhesive 5 is applied to the coating material 22. In this example, an adhesive diluent obtained by diluting the adhesive 5 with toluene was applied to a coated electrical wire 2 that is the same as Working Example 1. Thereafter, the adhesive diluent was air-dried.

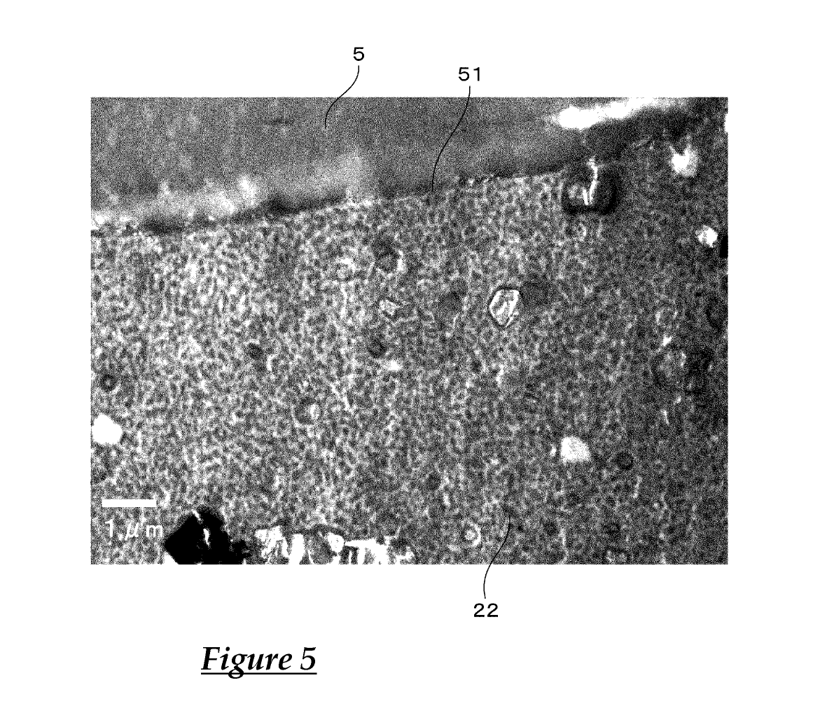

The vicinity of the interface between the adhesive 5 and the coating material 22 of a test piece obtained as above was observed by a TEM. A TEM photograph of a sample subjected to electron staining with RuO₄ is shown in FIG. 5. As is understood from FIG. 5, an interface 51 between the adhesive 5 and the coating material 22 was clear, and the mixed layer 7 whose color changes continuously was not observed therebetween. Thus, in order to form the mixed layer 7 between the adhesive 5 and the coating material 22, heat and pressure corresponding to those applied at the time of insert molding are required. Also, if the mixed layer 7 is not formed between the adhesive 5 and the coating material 22 as in this example, the force of adhering to each other is not sufficient and the adhesive 5 and the coating material 22 easily separate from each other. Therefore, connector-equipped electrical wires that do not have the mixed layer 7 tend to have low waterproofness.

1. A connector-equipped electrical wire comprising:
a coated electrical wire having a conductor and a coating material that is made of a cross-linked polyethylene resin and with which the conductor is coated;
a terminal metal fitting connected to an end portion of the coated electrical wire;
a connector housing in which the end portion is embedded and that is integrally formed with the coated electrical wire and the terminal metal fitting; and
an adhesive that is disposed in a portion of a gap located between the coating material at the end portion and the connector housing, and seals the gap,
wherein the adhesive contains one or more resins selected from the group consisting of a modified polyolefin-based resin, a modified polyamide resin, and a modified polyester resin, as an adhesive component, and
a mixed layer in which the adhesive and the coating material are mixed is formed between the adhesive and the coating material.

2. A method for manufacturing a connector-equipped electrical wire, comprising the steps of:
a terminal connection step of connecting a terminal metal fitting to an end portion of a coated electrical wire having a conductor and a coating material that is made of a cross-linked resin and with which a periphery of the conductor is coated;
an adhesive application step of applying an adhesive containing one or more resins selected from the group consisting of a modified polyolefin-based resin, a modified polyamide resin, and a modified polyester resin and a non-protonic organic solvent to a surface of the coating material at the end portion; and
a connector molding step of forming a connector housing integrally with the coated electrical wire and the terminal metal fitting by insert molding in a state in which the non-protonic organic solvent remains in the adhesive, such that the end portion is embedded.

3. The method for manufacturing a connector-equipped electrical wire according to claim 2, wherein
the non-protonic organic solvent is a solvent selected from the group consisting of aromatic hydrocarbon and methyl ethyl ketone, or a solvent in which two or more thereof are mixed.
